(19) United States
(12) Patent Application Publication
(10) Pub. No.: US 2023/0182631 A1
(43) Pub. Date: Jun. 15, 2023

(54) HEADREST FOR A SEAT, AND VEHICLE SEAT

(71) Applicant: Adient US LLC, Plymouth, MI (US)

(72) Inventors: Michal MARTINKA, Nove Mesto nad Vahom (SK); Miroslav REZBARIK, Trencin (SK)

(21) Appl. No.: 17/996,798

(22) PCT Filed: Apr. 16, 2021
(86) PCT No.: PCT/EP2021/059950

§ 371 Date: Oct. 21, 2022

(30) Foreign Application Priority Data
Apr. 23, 2020 (DE) 10 2020 205 186.0
Aug. 5, 2020 (DE) 10 2020 120 640.2

(51) Int. Cl. B60N 2/815; B60N 2/818; B60N 2/894

(52) U.S. Cl. CPC B60N 2/815; B60N 2/818; B60N 2/894; B60N 2205/30

(57) ABSTRACT

A headrest may have at least one headrest body, a base support element, on which the headrest body is arranged such that the height can be adjusted and it can be locked in a height position, and a retaining element, with which the headrest body is arranged in a height-adjustable manner on the base support element. The retaining element can be detachably blocked in the adjusted height position. The retaining element engages through the base support element, and the retaining element is connected to the headrest body on both sides of the base support element. The headrest may also have a locking element for locking and unlocking the retaining element in the adjusted height position. The retaining element is guided in a height-adjustable manner on the base support element. A motor vehicle seat may have the headrest.

The invention relates to a headrest comprising at least a headrest body, a base supporting element, on which the headrest body is arranged in a height-adjustable manner and so as to be arrestable in a height position, a holding element, by which the headrest body is arranged in a height-adjustable manner on the base supporting element, wherein the holding element is able to be releasably arrested in the set height position, the holding element engages through the base supporting element, and the holding element is connected to the headrest body on both sides of the base supporting element, and a locking element for unlocking and locking the holding element in the set height position. The invention moreover relates to a vehicle seat having such a headrest.

### PRIOR ART

Various height-adjustable headrests which are height-adjustable relative to a backrest of a seat are known from the prior art.

DE 20 2009 013 635 U1 has disclosed a headrest comprising a headrest body, a base supporting element, on which the headrest body is arranged in a height-adjustable manner and so as to be arrestable in a height position, a holding element, by which the headrest body is arranged in a height-adjustable manner on the base supporting element, wherein the holding element is able to be releasably arrested in the set height position, and a locking element for unlocking and locking the holding element in the set height position. The holding element is fastened to a lower frame strut of the headrest body and to an upper frame strut of the headrest body. The holding element engages through the base supporting element without being guided therein. The headrest body, and along therewith the holding element, is guided in a height-adjustable manner on two guiding rods.

U.S. Pat. No. 10,040,382 B2 discloses a headrest having a headrest body which has a front headrest sub-element, having a head-bearing surface, and has a rear headrest sub-element, wherein the front headrest sub-element is guided so as to be relatively movable with respect to the rear headrest sub-element.

DE 20 2018 102 807 U1 discloses a headrest assembly comprising a fixed rear housing, which encloses a first and a second drive, an attachment panel, which is positioned outside the fixed rear housing and, for the purpose of horizontal and vertical setting of the attachment plate, is operatively connected to the first and second drives, a headrest cushion, which has a central supporting element which is coupled to the attachment plate such that it is able to be pivoted between an upright position and an angled position; and a first and a second side bearing part, which are pivotably coupled to opposite ends of the central supporting element, wherein the first and second side bearing parts are operable between extended and retracted positions.

DE 10 2007 048 152 B3 has disclosed a vehicle seat comprising a seatback for holding the back of an occupant, a rod, which is fitted to the seatback and extends therefrom, a stop, which is fitted to the rod, a frame, which is fitted to the rod in such a way that it can slide along the rod, a headrest, which is fitted to the frame, to hold the head of an occupant, a blocking mechanism, which interacts with the stop and the frame so as to provide incremental blocking positions of the frame relative to the stop, and an actuation member, which releases the blocking mechanism in order that the headrest and the frame can slide along the rod, wherein the blocking mechanism comprises a rotatable shaft, wherein the shaft or the stop has a series of depressions provided in the longitudinal direction, and wherein the in each case other member has at least one projection which, in a blocked rotational position of the shaft, is connected to a depression from the series of depressions, while the at least one projection, in a released rotational position of the shaft, is released from the series of depressions, so that the headrest and the frame can slide along the rod.

DE 10 2010 061 308 A1 discloses a height-adjustable headrest for a vehicle seatback comprising fixed pins, which are intended to be connected to the backrest and extend substantially vertically, a movable framework, which is mounted in a displaceable manner on the pins, and a locking means, which is coupled to the movable framework and is able to be displaced on this along a horizontal direction in such a manner that the framework can be locked to the pins in a multiplicity of positions, wherein the headrest comprises a crossmember which connects the upper ends of the pins, wherein the crossmember and the locking means comprise detents and teeth, which are intended to interact with one another in such a way that the framework can be locked, with respect to the crossmember, in one of the multiplicity of positions.

### Problem

The invention is based on the problem of improving a headrest of the type mentioned in the introduction, in particular of designing such a headrest in a easier and less expensive manner, and of providing a corresponding vehicle seat.

### Solution

Said problem is achieved according to the invention by a headrest comprising at least a headrest body, a base supporting element, on which the headrest body is arranged in a height-adjustable manner and so as to be arrestable in a height position, a holding element, by which the headrest body is arranged in a height-adjustable manner on the base supporting element, wherein the holding element is able to be releasably arrested in the set height position, the holding element engages through the base supporting element, and the holding element is connected to the headrest body on both sides of the base supporting element, and a locking element for unlocking and locking the holding element in the set height position, wherein the holding element is guided in a height-movable manner on the base supporting element.

The fact that the holding element is guided in a height-movable manner, that is to say substantially in a vertical direction z, on the base supporting element means that particularly inexpensive guidance of the headrest body in the base supporting element is provided.

The headrest is height-adjustable. The headrest has the base supporting element and the holding element, which is arranged thereon or therein and is guided so as to be height-displaceable in particular substantially parallel to a vertical direction. The holding element serves for receiving and securing a headrest body, in particular two headrest shells. For the purpose of forming a means for guiding and arresting the headrest body in at least one height position, the base supporting element preferably comprises a number of openings and a locking element which is movable relative to the base supporting element between an unlocked position and a locked position. The locking element is preferably guided so as to be movable in a transverse direction, in particular guided on the base supporting element so as to be movable in a transverse direction.

The holding element preferably comprises a number of connecting elements or guiding parts, wherein the connecting elements or guiding parts are able to be releasably arrested in a set height position of the headrest body by the locking element. The base supporting element may in this case be fastened to at least one supporting element. The supporting element may be held on a seat, in particular on a vehicle seat. The headrest body may be held on the seat by the at least one supporting element. The supporting element is for example in the form of a U-shaped supporting bracket or is formed by two supporting rods.

The advantages achieved with the invention are that a headrest body of the height-adjustable headrest is adjustable in a particularly simple manner heightwise, preferably substantially parallel to a vehicle vertical direction, and that the headrest has a particularly compact design and is simple to fit. The headrest according to the invention improves comfort and safety for a vehicle occupant.

One possible embodiment provides that the headrest body comprises at least two connectable headrest sub-elements, wherein the holding element connects the two headrest sub-elements. For example, the holding element comprises at least one connecting element, in particular a connecting pin or a connecting rod. In particular, provision is made of two connecting pins which extend through the base supporting element and connect the two headrest sub-elements, in particular headrest shells, to one another. Preferably, one headrest sub-element, in particular a front headrest shell, is arranged in front of the base supporting element and a further headrest sub-element, in particular a rear headrest shell, is arranged behind the base supporting element. The holding element, in particular the connecting pins, may serve both for connecting the headrest sub-elements and for holding the headrest body in the desired height position. The holding element is thus multi-functional.

Preferably, the base supporting element has at least one opening, preferably at least one opening which extends substantially parallel to a vertical direction, in which the holding element is arranged in a height-movable manner. In the case of an embodiment with two connecting pins, two openings, preferably two openings extending at least substantially parallel to a vertical direction, in particular elongated holes or slots, are correspondingly formed in the base supporting element. The connecting pins may serve both for connecting the headrest sub-elements and for holding the headrest body in the desired height position.

The locking element may be movable relative to the holding element and to the base supporting element between an unlocked position and a locked position. The locking element is for example in the form of a locking slide or a movable locking plate. The locking element may be guided in a movable manner. The locking element may be guided so as to be movable in a transverse direction.

Preferably, the locking element is guided on the base supporting element in a movable manner. The locking element may form a subassembly with the base supporting element.

The locking element may have a number of locking receptacles, wherein, in each locked height position, the holding element engages into one of the locking receptacles such that the headrest body is arrested against height adjustment.

Provision may be made of a restoring element which moves the locking element from the unlocked position into the locked position. If the locking element is moved for example by an actuation element from the locked position into the unlocked position, when the actuation element, for example an actuation button, is released, the locking element is moved automatically into the locked position by the restoring element, in which locked position the holding element engages into the corresponding locking receptacle in an arresting manner and the headrest body is consequently arrested against height adjustment.

One possible configuration of the headrest according to the invention provides that the holding element is manually height-adjustable in relation to the base supporting element, in particular is mounted in a height-displaceable manner in the base supporting element. In a preferred embodiment, the holding element comprises two connecting elements which are in the form of guiding parts, in particular guiding pins. In this way, the aforementioned advantages are achievable in a particularly simple and convenient manner.

The holding element may have a number of connecting elements in the form of guiding parts, in particular two guiding parts, for example two guiding pins. In this way, it is possible for the holding element, together with the headrest body held thereby, to be able to be displaced particularly effectively in the base supporting element, in particular to be able to be displaced substantially parallel to the vertical direction, and to be able to be releasably arrested in a set height position on the base supporting element by the locking element. In the case of a configuration of the connecting elements of the holding element as connecting pins moreover serving as guiding pins, the base supporting element, for the purpose of forming a guide for the connecting pins, has a number of openings, in particular two openings, for example two elongated holes or slots.

The holding element is configured to hold the headrest body such that it is height-adjustable in relation to the base supporting element. For example, the two connecting pins and/or guiding pins of the holding element connect two body shells of the headrest body, in particular a front shell and a rear shell, fixedly to one another.

The locking element is for example in the form of a locking plate which is adjustable between an unlocked position and a locked position or in the form of a slide, wherein, in the unlocked position of the locking element, the headrest body is freely movably, in particular height-displaceable, and, in the locked position, a movement of the headrest body, in particular upward and downward, is prevented and the headrest body is thereby arrested.

An actuation element, in particular an actuation button, may be provided for the purpose of actuation of the height adjustment of the headrest. The actuation element may be coupled in terms of movement to the locking element. Through actuation of the actuation element, the locking element is able to be transferred from a locked position into an unlocked position, so that the holding element, and along therewith the headrest body, is freely movable, in particular height-displaceable. When the actuation element is released, or if the latter is not actuated, the locking element is moved automatically, for example by way of a spring force, in relation to the base supporting element into the locked position and provides locking action. For this purpose, a restoring element, in particular a restoring spring, is provided.

The invention is moreover achieved by a vehicle seat having a headrest according to the invention, which is arranged in a height-adjustable manner on the vehicle seat, in particular on a backrest of the vehicle seat.

### FIGURES AND EMBODIMENTS OF THE INVENTION

Below, the invention is discussed in more detail on the basis of an advantageous exemplary embodiment illustrated in the figures. The invention is however not restricted to said exemplary embodiment. In the figures, schematically:

FIG. 1 shows a side view of a vehicle seat according to the invention with a headrest according to the invention,

FIG. 2 shows, in a perspective view, the headrest according to the invention having a height-adjustable headrest body which is arranged on a supporting element,

FIG. 3A shows a side view of the headrest according to the invention, wherein a headrest body is arranged in a lower height position,

FIG. 3B shows a further side view of the headrest according to the invention, wherein the headrest body is arranged in an upper height position,

FIG. 4 shows the headrest according to the invention in an exploded illustration,

FIG. 5 shows a rear view of the headrest according to the invention without the headrest body, with an illustration being given of a base supporting element and a locking element in a locked position,

FIG. 6 shows a rear view of the headrest according to the invention without the headrest body, with an illustration being given of the base supporting element and the locking element in an unlocked position,

FIG. 7 shows a perspective rear view of the headrest according to the invention without a rear-side headrest shell, with an illustration being given of the locking element in a locked position,

FIG. 8 shows a side view, illustrated in section, of the headrest according to the invention, with an illustration being given of the locking element in the locked position and of the headrest body in the lower height position, and

FIG. 9 shows a side view, illustrated in section, of the headrest according to the invention, with an illustration being given of the locking element in the locked position and of the headrest body in the upper height position.

Parts which correspond to one another are denoted by the same reference signs in all the figures.

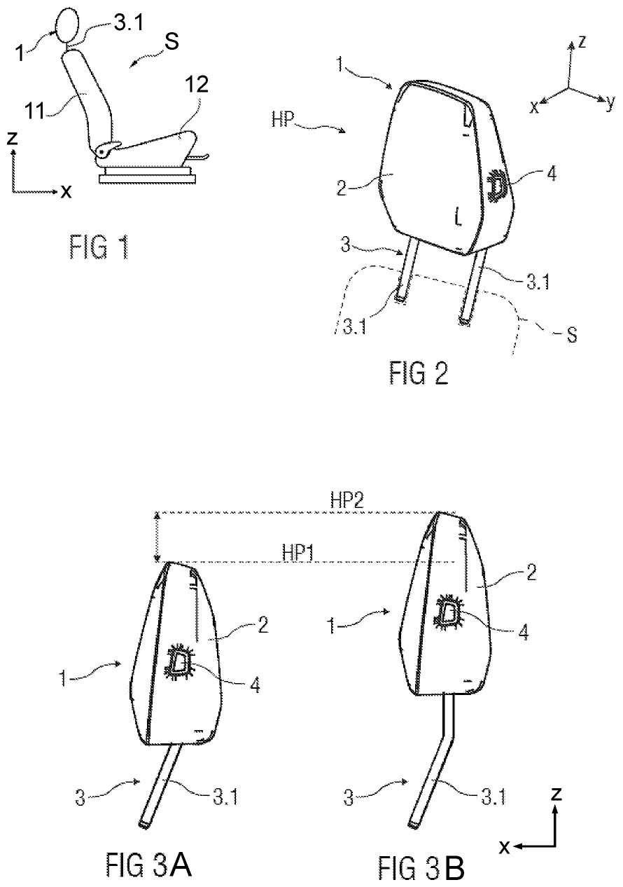

A vehicle seat S illustrated schematically in FIG. 1 will be described below using three spatial directions which are perpendicular to one another. In the case of a vehicle seat S installed in the vehicle, a longitudinal direction x is substantially horizontal and preferably parallel to a vehicle longitudinal direction, which corresponds to the normal direction of travel of the vehicle. A transverse direction y perpendicular to the longitudinal direction x is likewise oriented horizontally in the vehicle and is parallel to a vehicle transverse direction. A vertical direction z is perpendicular to the longitudinal direction x and perpendicular to the transverse direction y. In the case of a vehicle seat S installed in the vehicle, the vertical direction z is preferably parallel to a vehicle vertical axis.

The positional indications and directional indications used, such as for example front, rear, top and bottom, relate to a viewing direction of an occupant seated in the vehicle seat S in a normal seating position, wherein the vehicle seat S is installed in the vehicle, is in a use position suitable for conveying passengers, with an upright backrest 11, and is oriented in the conventional manner in the direction of travel. The vehicle seat S according to the invention may however also be installed in a different orientation, for example transversely to the direction of travel.

The vehicle seat S has the backrest 11 and a seat part 12. A headrest 1 according to the invention is arranged on the backrest 11. FIG. 2 schematically shows, in a perspective view, the headrest 1 with a height-adjustable headrest body 2.

The headrest body 2 may be produced from natural materials or from a plastic material or from a combination of the two. The headrest body 2 is arranged on a supporting element 3. The supporting element 3 is in turn able to be arranged on, preferably able to be to, the vehicle seat S. FIG. 2 shows two rod ends 3.1 of the supporting element 3, which serve for fastening the height-adjustable headrest 1 to the vehicle seat S.

For the purpose of height adjustment of the headrest body 2 relative to the supporting element 3, an actuation element 4 is arranged on the headrest body 2, through the actuation of which actuation element an arresting action of the headrest body 2 in a height position HP is able to be released, whereby the headrest body 2 is freely movable, and thus height-displaceable, upward or downward (in the present case substantially in and counter to the vertical direction z). By way of the wording “substantially parallel to the vertical direction z”, angular deviations in relation to the vertical direction z, which result in particular from a comfort-angle setting of the backrest 11, are also intended to be included. Said angular deviations may be up to 30 degrees in relation to the vertical direction z.

The headrest body 2 is, in particular substantially parallel to the vertical direction z, height-adjustable in a stepped manner and able to be selectively releasably arrested in one of multiple height positions HP. The height positions of the stepping are a lower height position HP1, an upper height position HP2 and multiple height positions HP arranged between the lower height position HP1 and the upper height position HP2. FIG. 3A shows the headrest 1, wherein the headrest body 2 is arrested in a height position HP1, which is a lower height position relative to the supporting element 3. FIG. 3B shows the headrest body 2 in a height position HP2, which is an upper height position relative to the supporting element 3.

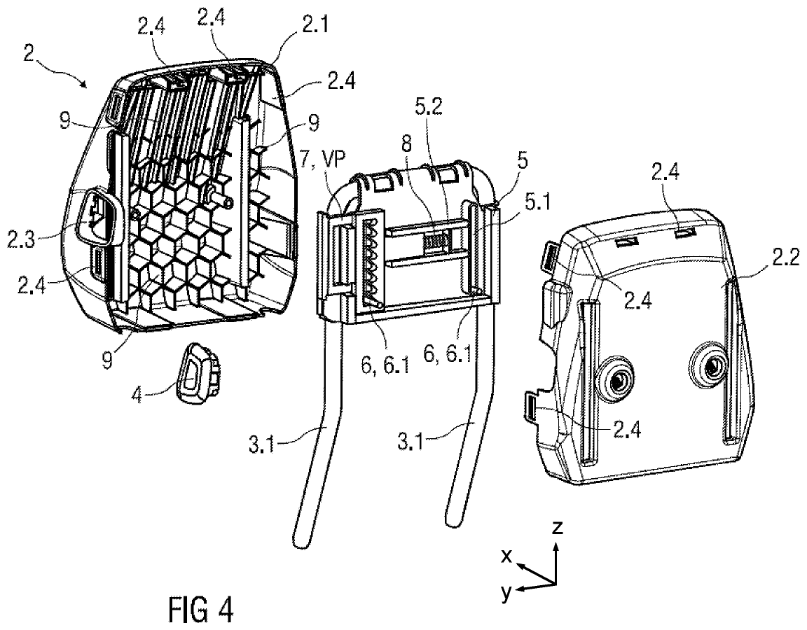

FIG. 4 shows the exemplary embodiment of the headrest 1 in an exploded illustration. The headrest 1 comprises a base supporting element 5, and a holding element 6 which is arranged therein and is able to be guided so as to be height-displaceable in particular substantially parallel to the vertical direction z. The holding element 6 is in this case arranged so as to be movable, in particular height-movable, in particular height-displaceable, in the base supporting element 5 and thus relative to the base supporting element 5. Furthermore, the holding element 6 is arranged or mounted on the base supporting element 5 so as to be height-movable, in particular height-displaceable, relative to the supporting element 3.

The supporting element 3 is in the form of a U-shaped supporting bracket in the exemplary embodiment. Alternatively, the supporting element 3 may be in the form of a pair of supporting rods. The supporting element 3 may be formed from a plastic material or from a metal or from a metal alloy.

The base supporting element 5 is formed from a plastic material, in particular a high-strength plastic material. The base supporting element 5 is fastened to, in particular held in a form-fitting and/or force-fitting manner on, the at least one supporting element 3. The base supporting element 5 is consequently connected fixedly to the supporting element 3. Consequently, the height positions HP, HP1, HP2 relate to the base supporting element 5 too.

The holding element 6 serves for receiving and securing the headrest body 2 on the base supporting element 5. The holding element 6 engages for example through the base supporting element 5 or extends through the latter and is connected to the headrest body 2 on both sides of the base supporting element 5.

The headrest body 2 is formed from two connectable headrest sub-elements, in particular two headrest shells 2.1 and 2.2. In the present case, a front headrest shell 2.1 is arranged substantially in front of the base supporting element 5 and a rear headrest shell 2.2 is arranged substantially behind the base supporting element 5.

The holding element 6 is manually height-adjustable, in particular height-displaceable, in relation to the base supporting element 5. The holding element 6 is configured to hold the headrest body 2 and, during a height adjustment, to guide the latter. For this purpose, the holding element 6 comprises a number of connecting elements, which at the same time are guiding parts, in the present case two pins 6.1. The pins 6.1 are in the form of combined connecting pins, holding pins and guiding pins. The two headrest shells 2.1 and 2.2 are connected fixedly to one another by the two pins 6.1. The headrest shells 2.1 and 2.2 are moreover guided so as to be height-adjustable relative to the base supporting element 5, and held in a releasably arrestable manner in one of the set height positions HP, HP1, HP2, by the two pins 6.1. The pins 6.1 are oriented substantially parallel to the longitudinal direction x. By way of the wording “substantially parallel to the longitudinal direction x”, angular deviations in relation to the longitudinal direction x of up to 30 degrees are intended to be included.

Additionally, the headrest shells 2.1 and 2.2 may have mutually corresponding fastening means 2.4, for example clips and clip openings, by which the headrest shells 2.1 and 2.2 are able to be releasably connected to one another.

For the purpose of forming a means for guiding and arresting the headrest body 2 in one of the height positions HP, HP1, HP2, the base supporting element 5 comprises a number of openings 5.1 into which the holding element 6, in particular the pins 6.1, are guided in a height-displaceable manner. The openings 5.1 are for example in the form of passage openings which extend parallel to the vertical direction z, for example elongated holes or passage grooves.

The number of openings 5.1 corresponds in particular to the number of pins 6.1. The headrest body 2 is thus able to be displaced particularly effectively in the base supporting element 5, in particular substantially parallel to the vertical direction z.

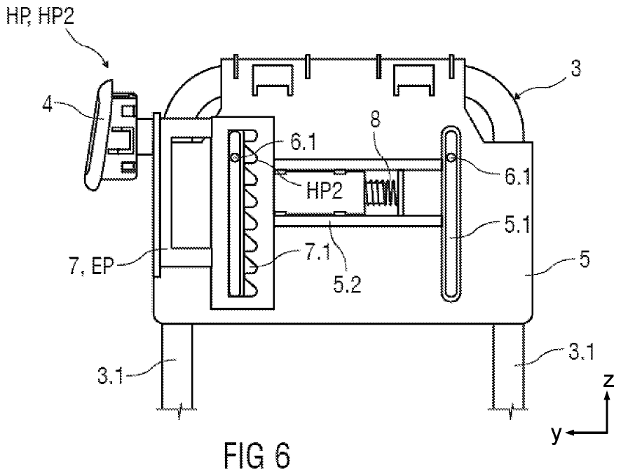

The headrest 1 furthermore comprises a locking element 7 which is movable relative to the base supporting element 5 between a locked position VP (illustrated in FIGS. 4, 5 and 7) and an unlocked position EP (illustrated in FIG. 6). The headrest body 2 is able to be releasably arrested in a set height position HP, HP1 or HP2 on the base supporting element 5, and thus in relation to the vehicle seat S, by the locking element 7.

The locking element 7 is for example in the form of a plate-shaped locking element 7 which is movable in the transverse direction y or in the form of a slide. Preferably, the locking element 7 is guided in a movable manner on the base supporting element 5.

The actuation element 4, in particular an actuation button, is provided for the actuation of the height adjustment of the headrest 1. In the fitted state of the headrest 1, the locking element 7 is coupled in terms of movement to the actuation element 4.

When the actuation element 4 is actuated, the locking element 7 is moved from the locked position VP (illustrated in FIGS. 4, 5 and 7) into the unlocked position EP (illustrated in FIG. 6), so that the holding element 6, and along therewith the headrest body 2, is freely movable, in particular height-displaceable. When the actuation element 4 is released, or if the latter is not actuated, the locking element 7 is moved automatically, for example by way of spring force, in relation to the base supporting element 5 into the locked position VP and locks the holding element 6, whereby the headrest body 2 is fixed and held at the set height. For transfer of the locking element 7 into the locked position VP, a restoring element 8, in particular a restoring spring, is provided.

The restoring element 8 is arranged in a receptacle 5.2 of the base supporting element 5. One end of the restoring element 8 is in engagement with the base supporting element 5, and the opposite end of the restoring element 8 is in engagement with the locking element 7. When the actuation element 4 is actuated, and accordingly the locking element 7 is moved into the unlocked position EP, the restoring element 8 is subjected to stressing. When the actuation element 4 is released, the restoring element 8 can be relieved of stressing, whereby the locking element 7 is automatically reset into the locked position VP and the actuation element 4 is reset into its initial position or rest position.

The actuation element 4 may be in the form of an actuation button which is arranged in a cutout 2.3 of the headrest body 2 and is held so as to be movable relative thereto.

The headrest shells 2.1 and 2.2 may be provided on the inner side with reinforcement elements 9, in particular ribs and/or webs, such that they run in a longitudinal, crossing and/or transverse manner. The front headrest shell 2.1 has a head-bearing surface on the outer side and is correspondingly upholstered. The rear headrest shell 2.2 is of substantially planar form on the outer side and may comprise at least one receptacle, in particular latching grooves, plug-in receptacles or similar structures, which serve for example for receiving and securing mobile devices.

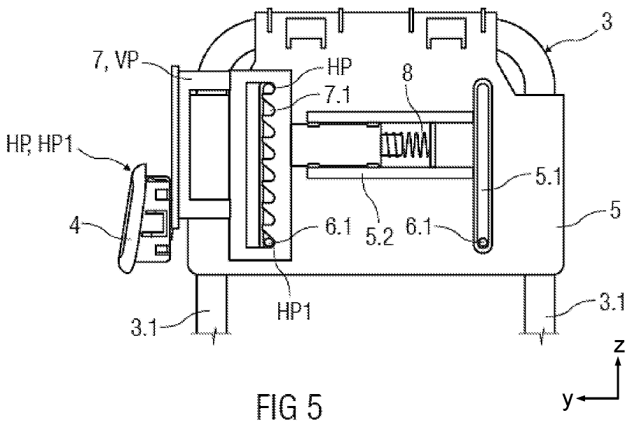

FIG. 5 schematically shows, without the headrest body 2, the headrest 1 with the base supporting element 5 and with the locking element 7 in the locked position VP. The actuation element 4 is in its initial position or rest position, a non-actuated position. The locking element 7 is designed in such a way that only one of the pins 6.1 is locked. Said pin 6.1 is in the form of a combined connecting means, guiding means and locking means that is both guided in an associated opening 5.1 so as to be height-displaceable during a height adjustment and able to be releasably arrested in a set height position HP, HP1, HP2, and that moreover connects the two headrest shells 2.1 and 2.2 to one another. The other pin 6.1 is only guided in an associated opening 5.1, and is not releasably arrestable.

The locking element 7 comprises a plurality of locking receptacles 7.1, which correspond to different height positions HP, HP1, HP2, wherein one pin 6.1 is able to be arranged in a releasably arrestable manner in one of said locking receptacles 7.1 according to the selected height positions HP, HP1, HP2.

In the present case, the locking element 7 is in the form of a locking plate which is adjustable between the locked position VP and the unlocked position EP, wherein, in the unlocked position EP, the headrest body 2 is freely movable, in particular height-displaceable, and, in the locked position VP, the movement of the headrest body 2, in particular upward and downward, is arrested.

In the locked position VP, the restoring element 8 is in a state relieved of stressing, wherein the locking element 7 is held in the locked position VP and the actuation element 4 is held in its initial position or non-actuated position.

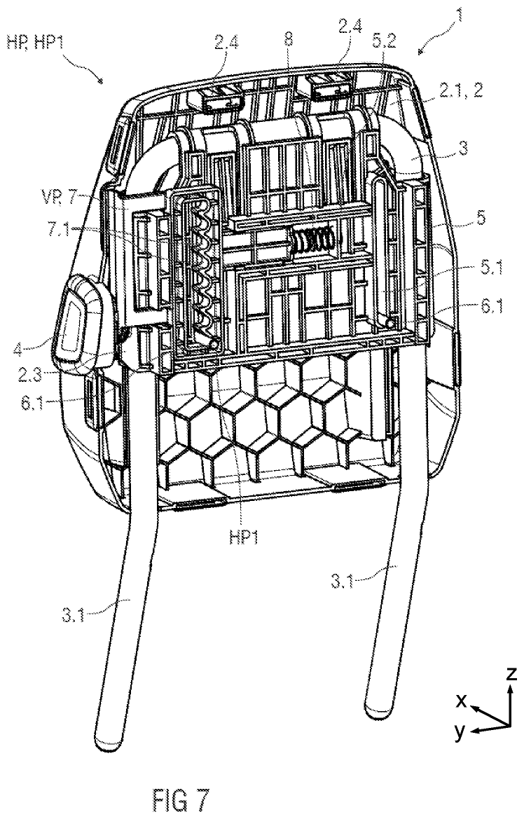

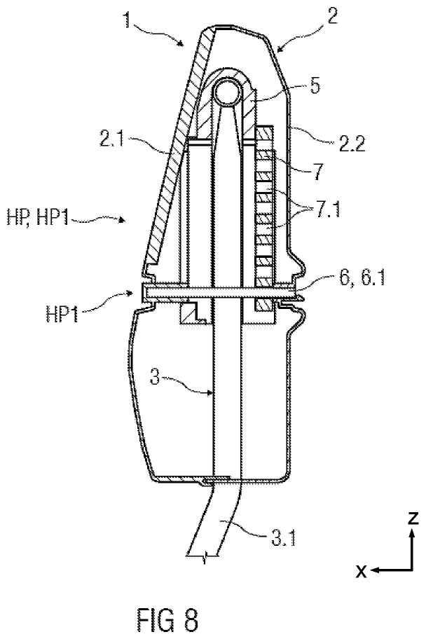

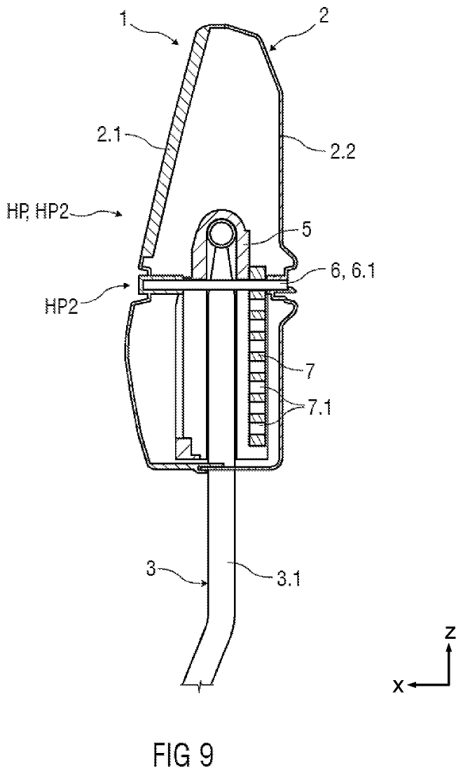

FIG. 6 shows the locking element 7 in the unlocked position EP, in which the pins 6.1 are guided in the openings 5.1 so as to be freely movable upward and downward. The restoring element 8 is in a state subjected to stressing. FIG. 7 shows the locking element 7 in the locked position VP. FIG. 8 shows the headrest body 2 in the lower height position HP1. FIG. 9 shows the headrest body 2 in the upper height position HP2.

The holding element 6 is configured to hold the headrest body 2 in a height-adjustable manner. For example, the two pins 6.1 connect the two body shells 2.1, 2.2 fixedly to one another.

The features which are disclosed in the above description, in the claims and in the figures can be of significance both individually and in combination for the realization of the invention in its various configurations, insofar as they remain within the scope of protection of the claims.

### LIST OF REFERENCE SIGNS

1 Headrest
2 Headrest body
2.1 (Front) headrest shell
2.2 (Rear) headrest shell
2.3 Cutout
2.4 Fastening means
3 Supporting element
3.1 Rod ends
4 Actuation element
5 Base supporting element
5.1 Opening
5.2 Receptacle
6 Holding element
6.1 Pin
7 Locking element
7.1 Locking receptacles
8 Restoring element
9 Reinforcement element
11 Backrest
12 Seat part
EP Unlocked position
HP Height position
HP1 Lower height position
HP2 Upper height position
S Vehicle seat
VP Locked position
x Longitudinal direction
y Transverse direction
z Vertical direction

1-15. (canceled)

16. A headrest comprising:
a headrest body,
a base supporting element, on which the headrest body is arranged in a height-adjustable manner and so as to be arrestable in a height position,
a holding element, by which the headrest body is arranged in a height-adjustable manner on the base supporting element, wherein the holding element is able to be releasably arrested in the set height position, the holding element engages through the base supporting element, and the holding element is connected to the headrest body on both sides of the base supporting element, and
a locking element for unlocking and locking the holding element in the set height position,
wherein
the holding element is guided in a height-movable manner on the base supporting element.

17. The headrest as claimed in claim 16, wherein the headrest body comprises at least two connectable headrest sub-elements, in particular two headrest shells and the holding element connects the two headrest sub-elements.

18. The headrest as claimed in claim 16, wherein the holding element is in the form of at least one connecting element.

19. The headrest as claimed in claim 16, wherein the holding element is in the form at least of at least one guiding part.

20. The headrest as claimed in claim 16, wherein the holding element is in the form of a guiding part which is able to be releasably arrested by the locking element (7).

21. The headrest as claimed in claim 16, wherein the holding element has at least one pin.

22. The headrest as claimed in claim 21, wherein the at least one pin is oriented substantially parallel to a longitudinal direction.

23. The headrest as claimed in claim 16, wherein the base supporting element has at least one opening extending in a vertical direction, in which the holding element is arranged in a height-movable manner.

24. The headrest as claimed in claim 16, wherein the locking element is movable relative to the holding element and relative to the base supporting element between an unlocked position and a locked position.

25. The headrest as claimed in claim 24, wherein the locking element has a number of locking receptacles.

26. The headrest as claimed in claim 25, wherein, in the locked position (VP), the holding element engages into one of the locking receptacles in an arresting manner.

27. The headrest as claimed in claim 24, wherein provision is made of a restoring element which moves the locking element from the unlocked position into the locked position.

28. The headrest as claimed in 16, wherein the base supporting element (5) is fastened to at least one supporting element.

29. A vehicle seat having a headrest as claimed in claim 16.

30. The vehicle seat as claimed in claim 29, wherein a supporting element of the headrest is arranged and held on a backrest of the vehicle seat.
